(19) United States
(12) Patent Application Publication
(10) Pub. No.: US 2025/0142388 A1
(43) Pub. Date: May 1, 2025

(54) METHOD AND APPARATUS FOR MEASUREMENT GAP CONFIGURATION WITH ADAPTIVE CONFIGURATION

(71) Applicant: MEDIATEK INC., Hsinchu City (TW)

(72) Inventors: Chi-Hsuan HSIEH, Hsinchu City (TW); Cheng-Hsun LI, Hsinchu City (TW); Yi-Chia LO, Hsinchu City (TW); Chia-Chun HSU, Hsinchu City (TW)

(21) Appl. No.: 18/836,045

(22) PCT Filed: Apr. 11, 2023
(86) PCT No.: PCT/CN2023/087567

§ 371 Date: Aug. 6, 2024

Related U.S. Application Data
(60) Provisional application No. 63/330,337, filed on Apr. 13, 2022.

(51) Int. Cl. H04W 24/10; H04W 76/28

(52) U.S. Cl. CPC H04W 24/10; H04W 76/28

(57) ABSTRACT

Various solutions for measurement gap configuration with adaptive configuration with respect to user equipment and network node in mobile communications are described. A network node may determine a traffic type. The network node may determine a measurement gap repetition period or a measurement gap length for the traffic type according to at least one condition. The network node may transmit a measurement gap configuration with the measurement gap repetition period or with the measurement gap length to a user equipment (UE).

### CROSS REFERENCE TO RELATED PATENT APPLICATION(S)

The present disclosure claims the priority benefit of U.S. Provisional Patent Application No. 63/330,337, filed on 13 Apr. 2022. The contents of aforementioned applications are herein incorporated by reference in their entirety.

### TECHNICAL FIELD

The present disclosure is generally related to mobile communications and, more particularly, to measurement gap configuration with adaptive configuration with respect to user equipment (UE) and network node in mobile communications.

### BACKGROUND

Unless otherwise indicated herein, approaches described in this section are not prior art to the claims listed below and are not admitted as prior art by inclusion in this section.

The wireless communications network has grown exponentially over the years. A long-term evolution (LTE) system offers high peak data rates, low latency, improved system capacity, and low operating cost resulting from simplified network architecture. LTE systems, also known as the 4G system, also provide seamless integration to older wireless network, such as GSM, CDMA and universal mobile telecommunication system (UMTS). In LTE systems, an evolved universal terrestrial radio access network (E-UTRAN) includes a plurality of evolved Node-Bs (eNodeBs or eNBs) communicating with a plurality of mobile stations, referred to as user equipment (UEs). The 3rd generation partner project (3GPP) network normally includes a hybrid of 2G/3G/4G systems. The next generation mobile network (NGMN) board, has decided to focus the future NGMN activities on defining the end-to-end requirements for 5G new radio (NR) systems and 6G systems.

In conventional communication technology, the UE may be configured a measurement gap for neighbor cell measurement. That is to say, in the measurement gap, the network node may not configure UE to transmit or receive data. However, for some real-time application (e.g., virtual reality (VR) or augmented reality (AR)), the services may be affected/interrupted when the UE needs to perform neighbor cell measurement on the configured measurement gap. The user experience will become bad.

Accordingly, how to maintain the service quality and reduce data interruption of the real-time application is worthy of discussion. Therefore, there is a need to provide proper schemes to design/configure measurement gaps.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to measurement gap configuration with adaptive configuration with respect to user equipment and network apparatus in mobile communications.

In one aspect, a method may involve a network node determining a traffic type. The method may also involve the network node determining a measurement gap repetition period or a measurement gap length for the traffic type according to at least one condition. The method may further involve the network node transmitting a measurement gap configuration with the measurement gap repetition period or with the measurement gap length to a user equipment (UE).

In one aspect, a network node may comprise a transceiver which, during operation, wirelessly communicates with a user equipment (UE). The network node may also comprise a processor communicatively coupled to the transceiver. The processor, during operation, may perform operations comprising determining a traffic type. The processor may also perform operations determining a measurement gap repetition period or a measurement gap length for the traffic type according to at least one condition. The processor may further perform operations comprising transmitting, via the transceiver, a measurement gap configuration with the measurement gap repetition period or with the measurement gap length to the UE.

In one aspect, a method may involve an apparatus determining a traffic type. The method may also involve the apparatus receiving a measurement gap configuration with a measurement gap repetition period or a measurement gap length from a network node. The measurement gap repetition period or the measurement gap length is determined for the traffic type based on at least one condition.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIOT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of an example process in accordance with an implementation of the present disclosure.

DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to measurement configuration with adaptive configuration with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

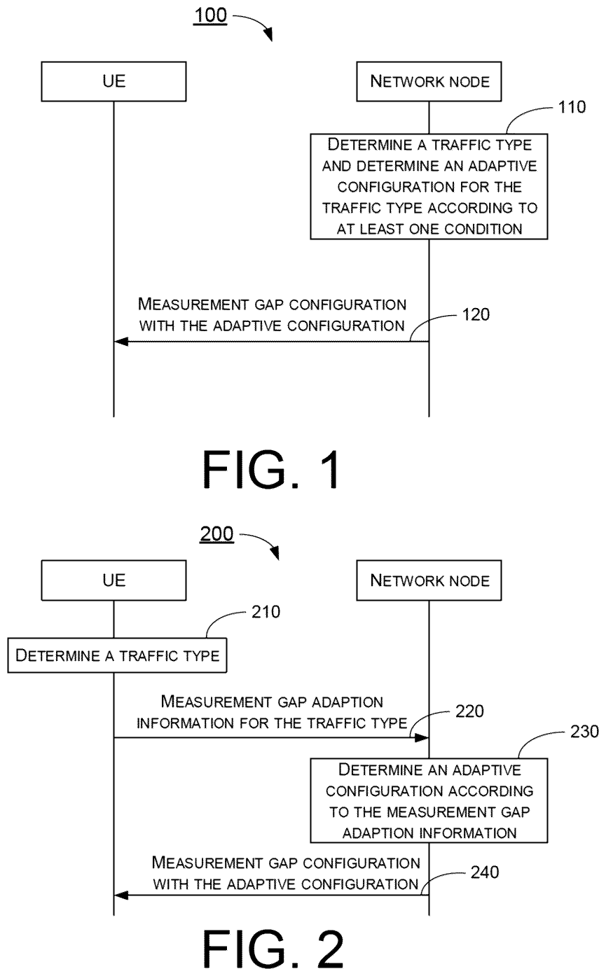

FIG. 1 illustrates an example scenario 100 under schemes in accordance with implementations of the present disclosure. Scenario 100 involves a UE and a network node, which may be a part of a wireless communication network (e.g., an LTE network, a 5G/NR network, an IoT network or a 6G network). As shown in FIG. 1, at 110, the network node may determine a traffic type and determine an adaptive configuration for the traffic type according to at least condition.

Specifically, the network node may determine whether the current traffic type is a specific traffic type. When the network node determines that the current traffic type is the specific traffic type, the network node may determine an adaptive configuration for the traffic type according to at least condition. For example, when the network node determines that the current traffic type is associated with an emerging application, e.g., extended reality (XR) which may comprise virtual reality (VR) and augmented reality (AR), the network node may determine that the current traffic type is the specific traffic type. Then, the network node may determine the adaptive configuration for the emerging application according to at least condition. In some implementations, the adaptive configuration may comprise measurement gap repetition period or measurement gap length for the specific traffic type.

In an example, the condition may comprise a video frame rate. For example, the video frame rate may be 60, 90, 120, 144 or 340 Hertz (Hz). The network node may determine the measurement gap repetition period according to the video frame rate. In an implementation, the network node may determine the measurement gap repetition period according to an integer multiple of a reciprocal of the video frame rate. For example, if the video frame rate is 60 Hz, the measurement gap repetition period may be an integer multiple of 1/60 seconds. In another implementation, the network node may determine an aggregated period according to an integer multiple of a reciprocal of the video frame rate. The aggregated period may comprise a plurality of measurement gap repetition periods, and each measurement gap repetition period of the aggregated period may be the same or different. For example, if the video frame rate is 60 Hz, the aggregated period may be an integer multiple of 1/60 seconds, where 1/60 seconds=0.0167 seconds=16.7 milliseconds (ms). Therefore, the aggregated period may comprise two measurement gap repetition periods, 16 ms and 17 ms. The two measurement gap repetition periods may be combined as 16 ms+17 ms+17 ms to form an aggregated period. That is, the aggregated period may be equal to or approached to 3 times of 1/60 seconds.

In another example, the condition may comprise a discontinuous reception (DRX) cycle. The network node may determine the measurement gap repetition period according to the DRX cycle. The measurement gap repetition period and the DRX cycle may have an integer multiple relationship. For example, if the DRX cycle period is L and the measurement gap repetition period is M, L may be an integer multiple of M or M may be an integer multiple of L.

In another example, the condition may comprise a specific period length. The network node may determine the measurement gap length according to the specific period length. The specific period length may be a small gap length which is smaller than the normal used measurement gap length. The network node may set the measurement gap length to be smaller than the specific period length. For example, if the specific period length is 3 ms, the network node may set the measurement gap length to 0.25, 0.5, 1, 1.5 or 2 ms.

Then, referring to FIG. 1, at 120, the network node may transmit a measurement gap configuration with the adaptive configuration to the UE. 5 FIG. 2 illustrates an example scenario 200 under schemes in accordance with implementations of the present disclosure. Scenario 200 involves a UE and a network node, which may be a part of a wireless communication network (e.g., an LTE network, a 5G/NR network, an IoT network or a 6G network). As shown in FIG. 2, at 210, the UE may determine a traffic type. At 220, the UE may transmit measurement gap adaption information for the traffic type to the network node through a physical uplink control channel (PUCCH), a physical uplink shared channel (PUSCH), or medium access control-control element (MAC-CE).

Specifically, at 210, the UE may determine whether the current traffic type is a specific traffic type. When the UE determines that the current traffic type is the specific traffic type, the UE may transmit measurement gap adaption information for the specific traffic type to the network node at 220 through PUCCH, PUSCH, or MAC-CE. For example, when the UE determines that the current traffic type is associated with an emerging application, e.g., XR which may comprise VR and AR, the UE may determine that the current traffic type is the specific traffic type. Then, the UE may transmit measurement gap adaption information for the emerging application to the network node.

In an example, the measurement gap adaption information may be used to suggest activating or deactivating one or more measurement gaps. The one or more measurement gaps may be activated or deactivated through radio resource control (RRC) signaling, MAC-CE or downlink control information (DCI). In another example, the measurement gap adaption information May be used to suggest measurement gap repetition period or measurement gap length for the specific traffic type.

At 230, the network node may determine an adaptive configuration for the traffic type according to the measurement gap adaption information from the UE. In some implementations, the adaptive configuration may comprise measurement gap repetition period or measurement gap length for the traffic type.

At 240, the network node may transmit a measurement gap configuration with the adaptive configuration to the UE.

The measurement gap configuration from the network node may be associated with one or more measurement gaps. For example, the measurement gap configuration may configure one or more measurement gaps. In some implementations of the disclosure, the measurement gap may comprise at least one of a measurement gap for band configuration, a measurement gap for positioning, a measurement gap for a radio link monitoring, a measurement gap for a beam failure detection, a measurement gap for a layer 1 (L1)-reference symbol received power (RSRP) measurement and a measurement gap for a candidate beam detection, etc.

### Illustrative Implementations

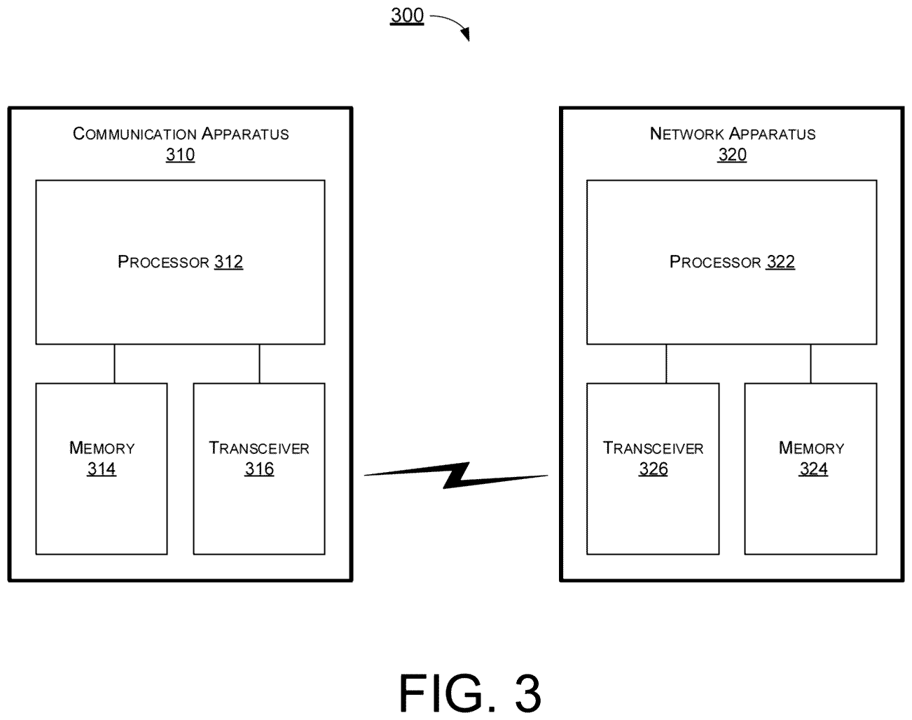

FIG. 3 illustrates an example communication system 300 having an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to measurement gap configuration with adaptive configuration with respect to user equipment and network apparatus in mobile communications, including scenarios/schemes described above as well as process 400 and process 500 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT, NB-IoT, or IIOT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of a network apparatus, which may be a network node such as a satellite, a base station, a small cell, a router or a gateway. For instance, network apparatus 320 may be implemented in an eNodeB in an LTE network, in a gNB in a 5G/NR, IoT, NB-IoT or IIOT network or in a satellite or base station in a 6G network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including autonomous reliability enhancements in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

In some implementations, processor 322 may determine a traffic type. Processor 322 may determine a measurement gap repetition period or a measurement gap length for the traffic type according to at least one condition. Processor 322 may transmit, via transceiver 326, a measurement gap configuration with the measurement gap repetition period or with the measurement gap length to communication apparatus 310.

In some implementations, the at least one condition may comprise a video frame rate. In some implementations, processor 322 may determine the measurement gap repetition period according to an integer multiple of a reciprocal of the video frame rate. In some implementations, processor 322 may determine an aggregated period according to an integer multiple of a reciprocal of the video frame rate. The aggregated period may comprise a plurality of measurement gap repetition periods, and each measurement gap repetition period of the aggregated period may be the same or different.

In some implementations, the at least one condition may comprise a DRX cycle. In some implementations, processor 322 may determine the measurement gap repetition period according to the DRX cycle. The measurement gap repetition period and the DRX cycle may have an integer multiple relationship.

In some implementations, processor 322 may determine the measurement gap length according to a specific period length. The measurement gap length may be smaller than the specific period length.

In some implementations, processor 322 may receive, via transceiver 326, a measurement gap adaption information from communication apparatus 310 through a PUCCH, a PUSCH, or a MAC-CE. Processor 322 may determine the measurement gap repetition period or the measurement gap length according to the measurement gap adaption information. In some implementations, the measurement gap adaption information may be used to suggest activating or deactivating one or more measurement gaps.

In some implementations, processor 312 may determine a traffic type. Processor 312 may receive, via transceiver 316, a measurement gap configuration with a measurement gap repetition period or a measurement gap length from network apparatus 320. The measurement gap repetition period or the measurement gap length may be determined for the traffic type based on at least one condition.

In some implementations, processor 312 may transmit, via transceiver 316, a measurement gap adaption information for the traffic type to network apparatus 320 through a PUCCH, a PUSCH, or a MAC-CE to determine the measurement gap repetition period or the measurement gap length.

### Illustrative Processes

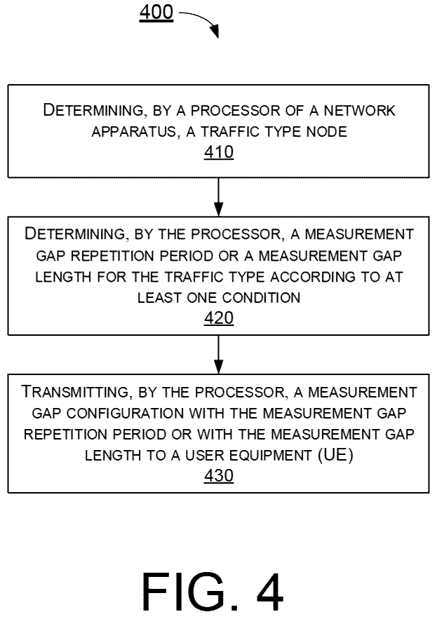

FIG. 4 illustrates an example process 400 in accordance with an implementation of the present disclosure. Process 400 may be an example implementation of above scenarios/schemes, whether partially or completely, with respect to measurement gap configuration with adaptive configuration with the present disclosure. Process 400 may represent an aspect of implementation of features of network apparatus 320. Process 400 may include one or more operations, actions, or functions as illustrated by one or more of blocks 410, 420 and 430. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by network apparatus 320 or any base stations or network nodes. Solely for illustrative purposes and without limitation, process 400 is described below in the context of network apparatus 320. Process 400 may begin at block 410.

At 410, process 400 may involve processor 322 of network apparatus 320 determining a traffic type. Process 400 may proceed from 410 to 420.

At 420, process 400 may involve processor 322 determining a measurement gap repetition period or a measurement gap length for the traffic type according to at least one condition. Process 400 may proceed from 420 to 430.

At 430, process 400 may involve processor 322 transmitting, by the processor, a measurement gap configuration with the measurement gap repetition period or with the measurement gap length to a UE.

In some implementations, process 400 may further involve processor 322 determining the measurement gap repetition period according to an integer multiple of a reciprocal of the video frame rate.

In some implementations, process 400 may further involve processor 322 determining an aggregated period according to an integer multiple of a reciprocal of the video frame rate. The aggregated period may comprise a plurality of measurement gap repetition periods, and each measurement gap repetition period of the aggregated period may be the same or different.

In some implementations, process 400 may further involve processor 322 determining the measurement gap repetition period according to the DRX cycle. The measurement gap repetition period and the DRX cycle may have an integer multiple relationship.

In some implementations, process 400 may further involve processor 322 determining the measurement gap length according to a specific period length. The measurement gap length may be smaller than the specific period length.

In some implementations, process 400 may further involve processor 322 receiving a measurement gap adaption information from the UE through a PUCCH, a PUSCH, a MAC-CE, and determining the measurement gap repetition period or the measurement gap length according to the measurement gap adaption information. The measurement gap adaption information is used to suggest activating or deactivating one or more measurement gaps.

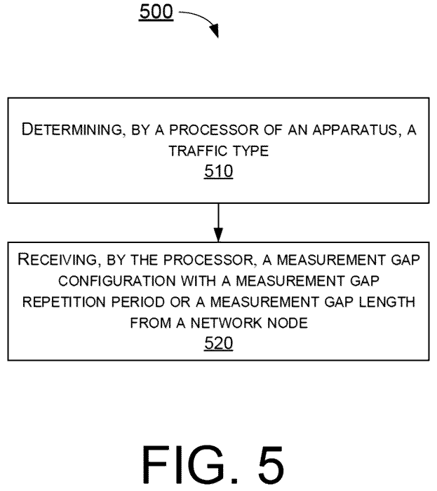

FIG. 5 illustrates an example process 500 in accordance with an implementation of the present disclosure. Process 500 may be an example implementation of above scenarios/schemes, whether partially or completely, with respect to data scheduling within measurement gaps with the present disclosure. Process 500 may represent an aspect of implementation of features of communication apparatus 310. Process 500 may include one or more operations, actions, or functions as illustrated by one or more of blocks 510 and 520. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by communication apparatus 310 or any suitable UE or machine type devices. Solely for illustrative purposes and without limitation, process 500 is described below in the context of communication apparatus 310. Process 500 may begin at block 510.

At 510, process 500 may involve processor 312 of communication apparatus 310 determining a traffic type. Process 500 may proceed from 510 to 520.

At 520, process 500 may involve processor 312 receiving a measurement gap configuration with a measurement gap repetition period or a measurement gap length from a network node. The measurement gap repetition period or the measurement gap length is determined for the traffic type based on at least one condition.

In some implementations, process 500 may further involve processor 312 transmitting a measurement gap adaption information for the traffic type to the network node through a PUCCH, a PUSCH, or a MAC-CE to determine the measurement gap repetition period or the measurement gap length.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of a network node, a traffic type;
determining, by the processor, a measurement gap repetition period or a measurement gap length for the traffic type according to at least one condition; and
transmitting, by the processor, a measurement gap configuration with the measurement gap repetition period or with the measurement gap length to a user equipment (UE).

2. The method of claim 1, wherein the at least one condition comprises a video frame rate.

3. The method of claim 2, wherein the determining of the measurement gap repetition period comprises:
determining, by the processor, the measurement gap repetition period according to an integer multiple of a reciprocal of the video frame rate.

4. The method of claim 2, wherein the determining of the measurement gap repetition period comprises:
determining, by the processor, an aggregated period according to an integer multiple of a reciprocal of the video frame rate,
wherein the aggregated period comprises a plurality of measurement gap repetition periods, and wherein each measurement gap repetition period of the aggregated period is the same or different.

5. The method of claim 1, wherein the at least one condition comprises a discontinuous reception (DRX) cycle.

6. The method of claim 5, wherein the determining of the measurement gap repetition period comprises:
determining, by the processor, the measurement gap repetition period according to the DRX cycle,
wherein the measurement gap repetition period and the DRX cycle have an integer multiple relationship.

7. The method of claim 1, wherein the determining of the measurement gap length comprises:
determining, by the processor, the measurement gap length according to a specific period length,
wherein the measurement gap length is smaller than the specific period length.

8. The method of claim 1, further comprising:
receiving, by the processor, a measurement gap adaption information from the UE through a physical uplink control channel (PUCCH), a physical uplink shared channel (PUSCH), or a medium access control-control element (MAC-CE); and
determining, by the processor, the measurement gap repetition period or the measurement gap length according to the measurement gap adaption information.

9. The method of claim 8, wherein the measurement gap adaption information is used to suggest activating or deactivating one or more measurement gaps.

10. A network node, comprising:
a transceiver which, during operation, wirelessly communicates with a user equipment (UE); and
a processor communicatively coupled to the transceiver such that, during operation, the processor performs operations comprising:
determining, by a processor of the network node, a traffic type;
determining, by the processor, a measurement gap repetition period or a measurement gap length for the traffic type according to at least one condition; and
transmitting, by the processor, a measurement gap configuration with the measurement gap repetition period or with the measurement gap length to the UE.

11. The network node of claim 10, wherein the at least one condition comprises a video frame rate.

12. The network node of claim 11, wherein, in determining the measurement gap repetition period, the processor determines the measurement gap repetition period according to an integer multiple of a reciprocal of the video frame rate.

13. The network node of claim 11, wherein, in determining the measurement gap repetition period, the processor determines an aggregated period according to an integer multiple of a reciprocal of the video frame rate, and wherein the aggregated period comprises a plurality of measurement gap repetition periods, and each measurement gap repetition period of the aggregated period is the same or different.

14. The network node of claim 10, wherein the at least one condition comprises a discontinuous reception (DRX) cycle.

15. The network node of claim 14, wherein, in determining the measurement gap repetition period, the processor determines the measurement gap repetition period according to the DRX cycle, and wherein the measurement gap repetition period and the DRX cycle have an integer multiple relationship.

16. The network node of claim 10, wherein, in determining the measurement gap length, the processor determines the measurement gap length according to a specific period length, and wherein the measurement gap length is smaller than the specific period length.

17. The network node of claim 10, wherein, during operation, the processor further performs operations comprising:
receiving, via the transceiver, a measurement gap adaption information from the UE through a physical uplink control channel (PUCCH), a physical uplink shared channel (PUSCH), or a medium access control-control element (MAC-CE); and
determining the measurement gap repetition period or the measurement gap length according to the measurement gap adaption information.

18. The network node of claim 17, wherein the measurement gap adaption information is used to suggest activating or deactivating one or more measurement gaps.

19. A method, comprising:
determining, by a processor of an apparatus, a traffic type;
receiving, by the processor, a measurement gap configuration with a measurement gap repetition period or a measurement gap length from a network node,
wherein the measurement gap repetition period or the measurement gap length is determined for the traffic type based on at least one condition.

20. The method of claim 19, further comprising:
transmitting, by the processor, a measurement gap adaption information for the traffic type to the network node through a physical uplink control channel (PUCCH), a physical uplink shared channel (PUSCH), or a medium access control-control element (MAC-CE) to determine the measurement gap repetition period or the measurement gap length.
